(19) United States
(12) Patent Application Publication
(10) Pub. No.: US 2022/0047111 A1
(43) Pub. Date: Feb. 17, 2022

(54) METHOD AND SYSTEM FOR ENCAPSULATED BEVERAGE PREPARATION AND BREWING

(71) Applicant: AKRONYM PTE LTD, Singapore (SG)

(72) Inventors: Jonathan Louis BUFORD, Cartersville, GA (US); Andre Chanco, Manila (PH); Bowen Chiou, Taipei City (TW); Leon Foo, Singapore (SG)

(73) Assignee: AKRONYM PTE LTD, Singapore (SG)

(21) Appl. No.: 17/343,651

(22) Filed: Jun. 9, 2021

Related U.S. Application Data
(60) Provisional application No. 63/064,220, filed on Aug. 11, 2020.

(51) Int. Cl. A47J 31/52; A47J 31/00

(52) U.S. Cl. CPC A47J 31/521; A47J 31/5251; A47J 31/007; A47J 31/5255; A47J 31/002; A47J 31/5253

(57) ABSTRACT

A coffee brewing process comprising the steps of: providing a coffee brewing device, having a plurality of coffee brewing elements; providing end user criteria; selecting recipes from a remote server based upon the end user criteria, said recipes including at least one data set corresponding to said recipe; downloading the recipe and corresponding at least one data set; adjusting settings of at least one coffee brewing element based upon the data set, and so; brewing coffee using said coffee brewing device at one element.

### BACKGROUND

Encapsulated coffee and tea brewing apparatus have become fairly common in the global marketplace due to providing a good compromise between quality, ease of use, and convenience. However, the existing machines do not provide as much control as can be found in café brewing machines, which offer integrated sensor feedback to control the key brewing factors of temperature, pressure, flow rate, and total dispensed water volume. Additionally, a benefit of the controlled nature of encapsulated brewing capsules is that it removes many of the variables of brewing preparation by having a consistent grind and dosage of the product to be brewed, making it much more likely to have repeatable success with brewing if the other key brewing factors can be controlled.

Through the use of recipes, auto calibration of capsules, and control of the brewing process via sensors and feedback control of the sensed factors, the brewing process can both be improved as well as opened to controlled experimentation by end users in ways that is only possible in professional grade brewing apparatus currently. Additionally, by incorporating the historical brewing data of users through the introduction of a centralized server to both process the data and to share updated brewing recipes the experience can be further improved over time.

### SUMMARY OF THE INVENTION

In a first aspect, the invention provides a coffee brewing process comprising the steps of: providing a coffee brewing device, having a plurality of coffee brewing elements; providing end user criteria; selecting recipes from a remote server based upon the end user criteria, said recipes including at least one data set corresponding to said recipe; downloading the recipe and corresponding at least one data set; adjusting settings of at least one coffee brewing element based upon the data set, and so; brewing coffee using said coffee brewing device at one element.

In a second aspect, the invention provides a coffee brewing system comprising: a plurality of coffee brewing machines; said coffee brewing machines in communication with a remote server; said coffee brewing machines arranged to receive recipes and corresponding data sets from the server; said coffee brewing machines further arranged to provide brewing data to said server; wherein the server is arranged to receive said brewing data and apply to a machine learning unit, said machine learning unit arranged to use said brewing data to modify the recipes and corresponding data sets for subsequent communication to the coffee brewing machines.

The present invention seeks to improve the brewing process and experience though an integrated control of the key brewing process factors: brewing pressure, water temperature, water flow rate, and total water mass. The user experience is improved by making these settings available on the brewing apparatus as well as by being able to create custom brewing recipes and being able to share or receive recipes from other users as well as by the roasters themselves. This interaction can be augmented through the use of a connected mobile device or computer which can display and modify more detailed settings as well as provide integrated purchases of additional brewing supplies.

By establishing recipes and data sets corresponding to said recipes, a uniformity of beverage may be established, as well as a degree of customization that may not have been previously available.

An underlying goal for the invention is providing an improved brewed beverage based upon a selected, recommended or automatically selected recipe. Improvement may be considered subjective, with the invention including an individual consumer's preference to select or modify a recipe that suits their taste, regardless of whether it meets wider appeal. Nevertheless, in some instances, a measure of an improved beverage may be important. To this end, unless stated otherwise, improvement in the brewed beverage may be measured by total dissolved solids and/or % extraction.

In one embodiment, the invention may provide the ability to remotely store recipes, that may then be locked to encompass a preferred style, or intermittently modified to improve the recipe or meet changing demand. Said recipes may then be distributed to customers to improve the coffee they have. This may provide the advantage of providing multiple different flavour outcomes based upon the same capsule, including individual customer preferences.

### BRIEF DESCRIPTION OF THE DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIG. 1 shows the brewing system and connectivity according to one embodiment of the present invention.

FIG. 2 shows the method for recipe-based brewing and corrections according to one embodiment of the present invention.

FIG. 3 shows the interface for user-defined brewing profiles according to one embodiment of the present invention.

FIG. 4 shows the brewing data and usage locally and on the networked server according to one embodiment of the present invention.

FIG. 5 shows an improved method for controlling a duty cycle for smoothing the output according to one embodiment of the present invention.

FIG. 6 shows an improved mechanism for rotary user input incorporating quadrature sensing and mechanical detents for feedback according to one embodiment of the present invention.

FIG. 7 shows a process for documenting and sharing brewing recipes according to one embodiment of the present invention.

FIG. 8 shows one embodiment of a brewing apparatus according to one embodiment of the present invention.

FIG. 9 shows a rotary dial interface and user interaction methods according to one embodiment of the present invention.

FIG. 10 shows a comparison of pressure profiles of various brewing systems according to one embodiment of the present invention.

### DETAILED DESCRIPTION

Exemplary embodiments of the invention are described below. Reference is made to the examples in a non-limiting sense. They are provided to illustrate more broadly applicable aspects of the present invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. All such modifications are intended to be within the scope of the claims made herein.

Throughout the description, reference is made to coffee, however the invention may also be implemented for different brewed beverages, for instance, tea and baby formula. To this end, whilst coffee is used as a convenient example of the application of the invention, the invention may also be used for different brewed beverages

The coffee brewing process (including tea and other hot water-based beverages) is defined by the ratio of brewing material, such as coffee to the amount of water used to produce the final beverage, the brewing ratio. In more detailed brewing, the amount of water over time, temperatures over time, and flow rate or pressure (the two being connected for a single physical system) are factors that can influence the extraction of soluble components of the material to be brewed. These factors or conditions of brewing can vastly change the flavor or consistency of the result. Too much water can lead to over extraction or dilution. Too little can lead to under extraction, which may result in a less balanced flavor due to missing some of the key components that contribute to the preferred brew. In the same way, variations in temperature, pressure, or amount of flow at a particular time can impact the extraction of soluble components.

It will be appreciated that, in measuring (and subsequently controlling) flow rate, this may be achieved using velocity meters for a given conduit size, inline flow meters, or mass-based systems where the mass of water is measured over a specific period of time. For a mass-based system, a duty cycle may drive the pump until the mass output of water is achieved and measure this against time. Further still, the flow rate may be emulated simply by driving a pump to achieve the required mass, and the flow rate estimated.

Further still, a target pressure or flow rate may be achieved, with incremental increases in pressure or flow rate, based upon a departure from that target, during the period.

For typical coffee brewing, temperatures can range over the whole spectrum from almost freezing water for cold brew process to the boiling temperature of water. In the case of warm or hot extraction, the most typical temperatures are between 85° C. to 97° C., but it may be preferable to use temperatures outside of this range in order to extract or limit the extraction of various compounds. The pressure used for brewing can vary from one Bar for a slower extraction to around fifteen Bar for high pressure extraction used for an espresso process. Most commonly, espresso brewing will be done at around nine Bar, but it is preferred to allow for a wider range than is typical within the industry for experimental purposes. The timing of the flow of water, including a low pressure soaking time prior to a higher pressure extraction time during the brewing cycle can impact the total extraction, as the introduction of the water into the material to be brewed to wet it out will begin dissolving the soluble materials within it prior to extracting them. It is possible to have an extremely long extraction process, which is most common in a cold brew process in order to limit the over extraction of undesirable compounds. In a hot extraction process, typical times will be limited to thirty to forty-five seconds, but can be as long as one to two minutes when using a very finely ground material or a larger amount of material which increases the resistance to flow rate and also changes the extraction process. For our process, we prefer to allow for longer or shorter extraction times than would otherwise be typically chosen. This allows both for experimentation by the end user as well as for unique extraction processes to be specified by a roaster that otherwise may not be possible with typical equipment.

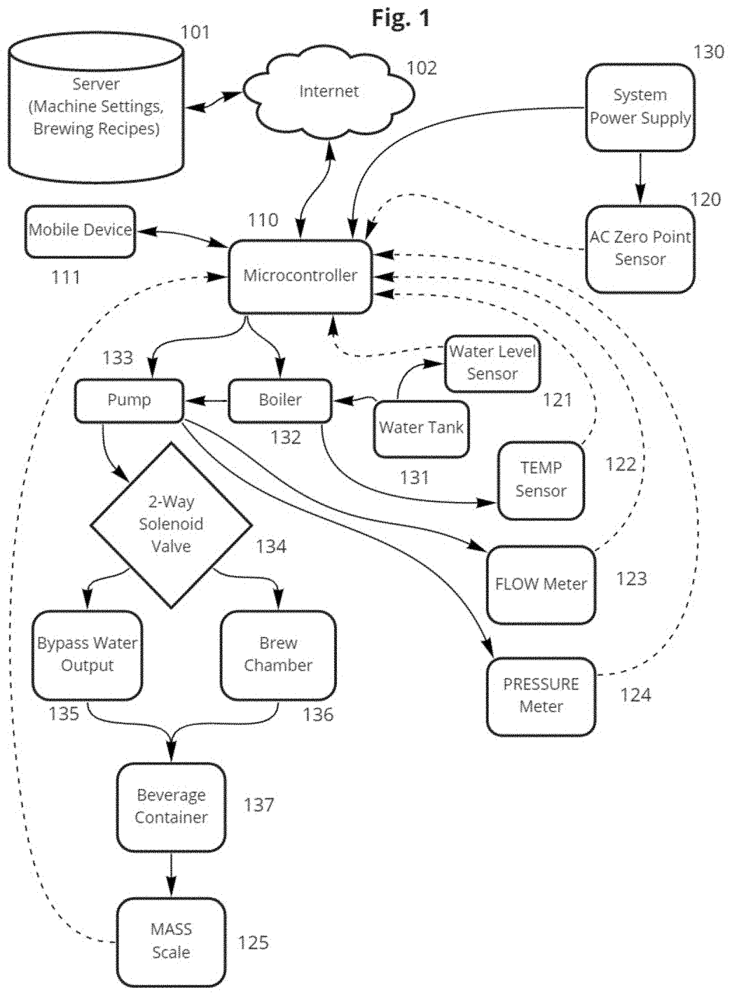

The core brewing apparatus is described by FIG. 1 which includes at least one or more microcontrollers 110 which interface to a variety of sensors and active elements 120-137 and more common user interface elements such as buttons, dials, lights, and display screens. The active elements of the brewing machine will include, but not limited to, those devices for which control is required to achieve the specified brewing parameters, for instance the boiler and flow pump. Additionally, this embedded system may be interfaced via wired or wireless network connections to external devices such as a mobile computer or phone 111 and a central server 101.

The basic brewing process involves at least bringing water from the Water Tank 131 into a boiler or thermal block heater via a pump 133 either before or after this heating apparatus. This is optionally controlled by a 2-Way Solenoid Valve 134 to either enter a brewing chamber 136 where the encapsulated material is held or to be sent directly into the beverage container 137 for direct dispensing via a water bypass outlet 135. In order to control the brewing process accurately, sensors for Temperature 122, Pumped Water Flow 123 are necessary. Additional sensors for Pressure 124, and output Mass 125 provide additional data to improve the accuracy and overcome limitations of systems that only have more limited sensing incorporated.

While all these sensors provide a fairly complete picture of the brewing process, it may be desired to include additional sensors at multiple locations to improve the accuracy and amount of data known about the brewing system. Additionally, it is possible to have an accurate enough system without the Pressure Sensor 124, as long as system calibration has been performed previously using a Pressure Sensor during system tuning, however, its inclusion will allow for ongoing system calibration and further accuracy over a fixed calibration and estimated pressure derived from other system sensors.

In the case of using an AC current vibration pump, which is the most common type for this apparatus, in order to control the output with more fidelity than a simple full on and off over a period of time, it is necessary to incorporate a sensor to monitor the voltage levels in order to time the switching on and off to happen when the voltage is at a low level where it crosses over from positive to negative or negative to positive, commonly referred to as Zero Point. This is sensed by the Zero Point Sensor 120 monitoring the system power supply 130.

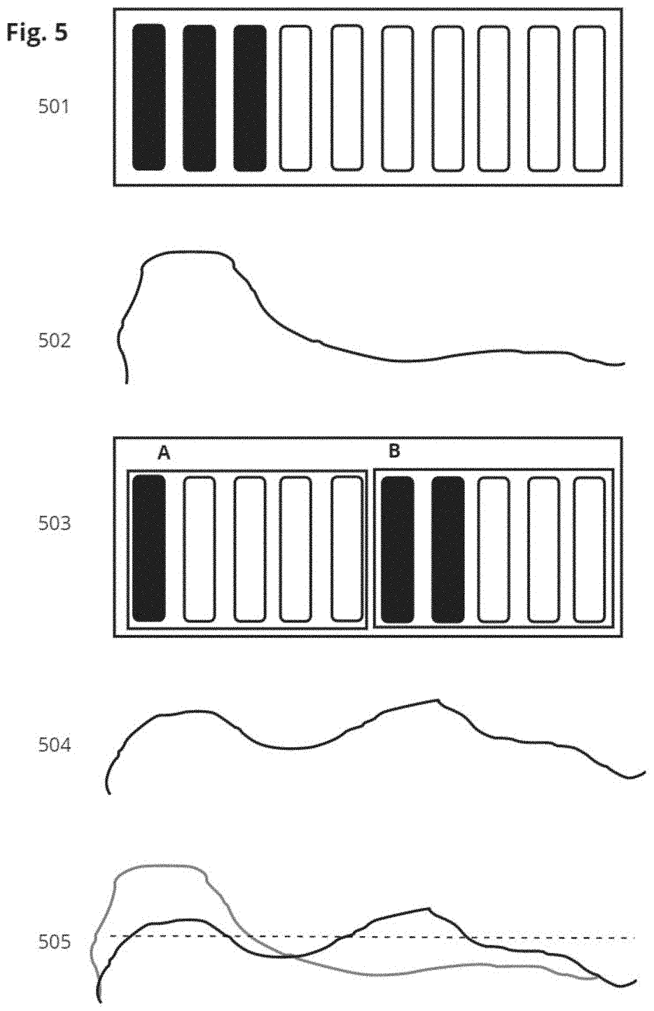

In order to have a wide range of duty cycle rates using a pump that is pulsed at the AC cycle rate, either 50 Hz or 60 Hz, it is possible to drop pulses over a period in order to reduce the total number of pulses during that period. As shown in FIG. 5, the most basic implementation of a duty cycle 501 typically creates a cycle with a fixed number of periods, ten are shown in the example, but this could be any number based on the frequency of the control system and the desired number of levels of duty cycle, however, with any system there will be a practical limit on what is usable. In the case of a vibration pump running at 50 Hz, the maximum practical number of duty cycle levels is around 20, which would make each period is 1/50^{th} of a second and the total cycle time of 400 milliseconds.

If a duty cycle of 30 percent is desired, as shown in 501, the most typical way of implementing driving is to put all on periods into the beginning of the cycle, however, this is generally used for higher frequency situations and to create a pulse wave modulation signal with just a single on and single off period during a cycle. With a slower rate drive system, such as the AC frequency driven pump, this results in a very rough drive with a clear on and off period during the cycle 502.

In order to smooth out the drive output and reduce the noise and vibration due to large fluctuations in pressure and flow, sub-dividing the total drive cycle into sub-cycles of fewer pulses and then distributing the desired duty cycle periods over those sub-cycles results in a smoother drive with less fluctuations 503 and 504. As shown in 503, for example, if the cycle originally included ten pulses, sub-dividing the cycle into two sub-cycles, a 30 percent duty cycle would require three total pulses distributed over the two sub-cycles. To distribute the pulses, the total number of cycles is divided by the number of sub-cycles, which results in one cycle per each sub-cycle. The remaining pulse is included in the final cycle, but it is possible to put it in any of the other sub-cycles if it is consistent from one cycle to the next. As shown in 505, this method reduces the peak pressure over the single cycle method. This results in quieter operation and smoother output.

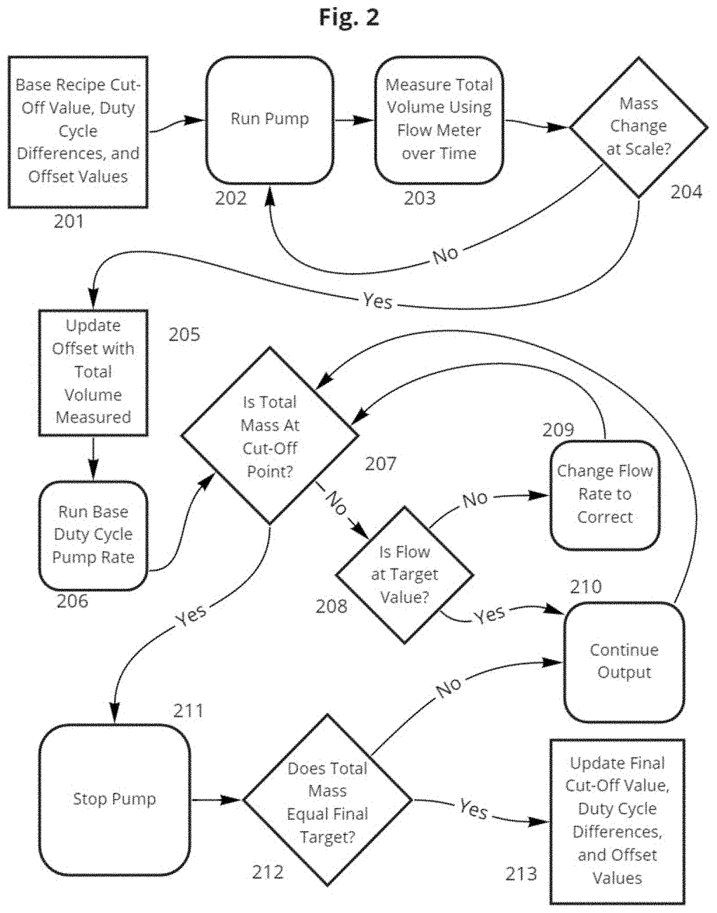

FIG. 2 illustrates the use of a brewing recipe that includes some detail of the amount of water, the temperature, pressure or flow rate, and total volume for a given period.

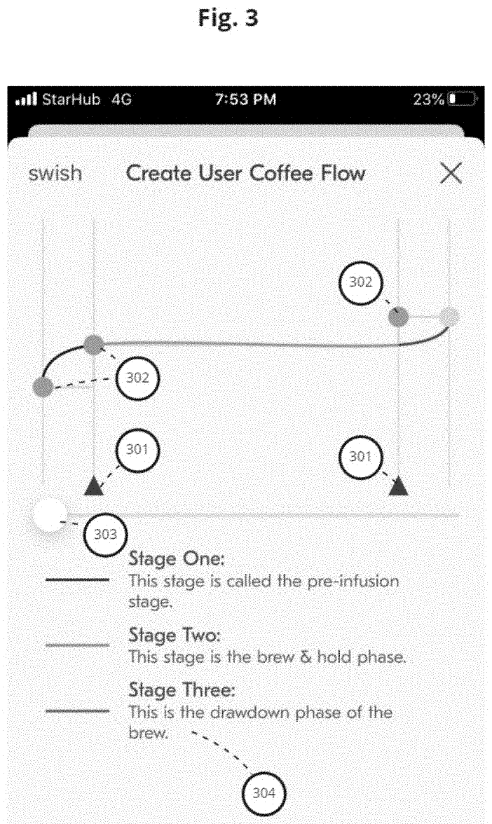

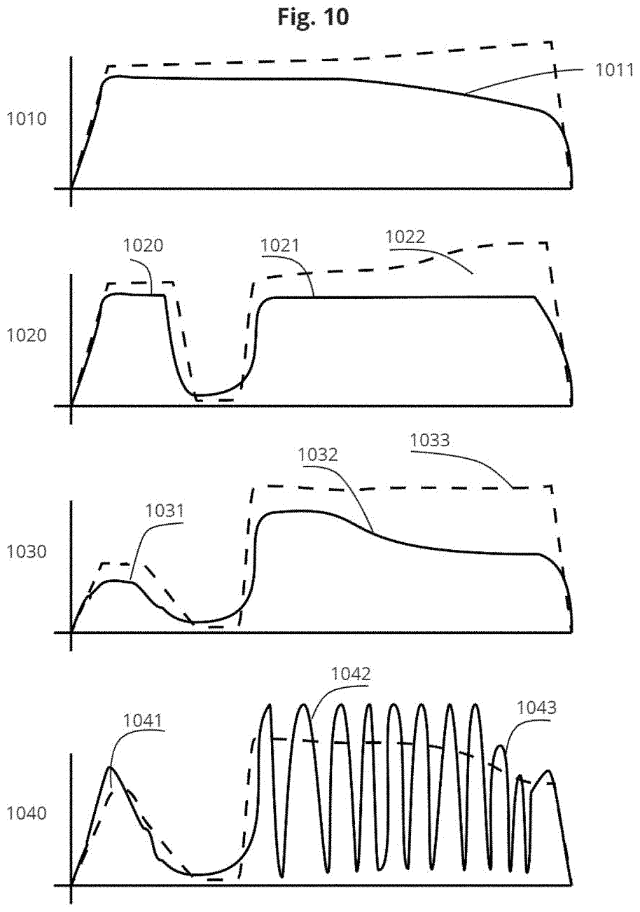

Table 1 shows an example recipe. The recipe may be defined in terms of a profile determining the flow rate, pressure or temperature required at stages during the brewing process. FIGS. 3 and 10 show example recipe profiles, whereby the values of the mentioned parameters at any particular stage is represented as a data set corresponding to the recipe.

As an example, a very simple temperature data set for a recipe may have define the water temperature during pre-infusion (T₁) and the temperature during the extraction phase (T₂). The temperature data set for a particular recipe may then define T₁>T₂ or T₂>T₁. As shown in the examples of FIG. 3 and FIG. 10, the data set may be considerably more prescriptive, by defining specific vales or ranges.

TABLE 1
Example Recipe #1

| | | | Bloom and | Bloom | | | | | | | |
|---|---|---|---|---|---|---|---|---|---|---|---|
| | | Total Mass | Brew pre- | and | Bloom and | | Mass of | | Mass of | | Mass of |
| | Tempera- | of | infusion | Brew | Brew Time | Stage | Water for | Stage | Water for | Stage | Water for |
| Brew Style | ture | Water (g) | settings | Level | (Mins) | #1 | Stage #1 (g) | #2 | Stage #2 (g) | #3 | Stage #3 (g) |
| Short Dark | 94 C. | 25 g | Yes | 3 | 5 | 3 | 5 g | 7 | 22 g | 2 | |
| Short Light | 93 C. | 45 g | No | | | 3 | 5 g | 7 | 28 g | 3 | |
| Long Light | 98 C. | 120 g | No | | | 4 | 10 g | [symbol] | 101 g | 4 | |
| Long Dark | 95 C. | 1 [symbol] 0 g | No | | | 3 | 2 g | 7 | 85 g | 5 | |
| Classic | 95 C. | 40 g | Yes | 3 | 10 | 3 | 5 g | 7 | 32 g | 7 | |
| [symbol] Filter Brew | 94 C. | [symbol] g | Yes | 2 | 30 | 2 | 5 g | 7 | 45 g | 4 | 25 g water by- |
| | | | | | | | | | | | pass |
| Bloom & Brew | [symbol] C. | 25 g | Yes | 2 | 20 | 2 | 5 g | 7 | 19 g | 5 | |
| Short for M [symbol] | [symbol] C. | 20 g | Yes | 2 | 15 | 2 | 5 g | 7 | 18 g | 5 | |
| Kyoto Style | 75 C. | 1 [symbol] 0 g | Yes | 1 | 20 | 1 | 5 g | 2 | 10 g | 1 | |
| Slow Drip | | | | | | | | | | | |
| [symbol] | 92 C. | 80 g | No | | | 2 | 10 g | 7 | 70 g | 3 | |

Example Recipe #2

| | | | Bloom and | Bloom | | | | | | | |
|---|---|---|---|---|---|---|---|---|---|---|---|
| | | Total Mass | Brew pre- | and | Bloom and | | Mass of | | Mass of | | Mass of |
| | Tempera- | of | infusion | Brew | Brew Time | Stage | Water for | Stage | Water for | Stage | Water for |
| Brew Style | ture | Water (g) | settings | Level | (Mins) | #1 | Stage #1 (g) | #2 | Stage #2 (g) | #3 | Stage #3 (g) |
| Short Dark | 94 C. | 25 g | Yes | 3 | 5 | 3 | 5 g | 7 | 22 g | 2 | |
| Short Light | [symbol] C. | 45 g | No | | | 3 | 5 g | 7 | [symbol] g | 3 | |
| Long Light | 98 C. | 120 g | No | | | 4 | 10 g | [symbol] | 101 g | 4 | |
| Long Dark | 95 C. | 1 [symbol] 0 g | No | | | 3 | 2 g | 7 | 85 g | 5 | |
| Classic | 95 C. | 40 g | Yes | 3 | 10 | 3 | 5 g | 7 | 32 g | 7 | |
| [symbol] Filter Brew | 94 C. | [symbol] g | Yes | 2 | 30 | 2 | 5 g | 7 | 45 g | 4 | 25 g water by- |
| | | | | | | | | | | | pass |
| Bloom & Brew | [symbol] C. | 25 g | Yes | 2 | 20 | 2 | 5 g | 7 | 19 g | 5 | |
| Short for M [symbol] | 92 C. | 20 g | Yes | 2 | 15 | 2 | 5 g | 7 | 18 g | 5 | |
| Kyoto Style | 75 C. | 1 [symbol] 0 g | Yes | 1 | 20 | 1 | 5 g | 2 | 10 g | 1 | |
| Slow Drip | | | | | | | | | | | |
| [symbol] | 92 C. | 80 g | No | | | 2 | 10 g | 7 | 70 g | 3 | |

[symbol]

indicates data missing or illegible when filed

Additionally, an offset value for the amount of water retained within the apparatus and capsule, proscribed duty cycles, and measured output at the scale to initiate cutting off the pump may be included per each specific brewing apparatus configuration. Recipes can include details as necessary to generate the desired output or within the capabilities of a given system. A recipe may be stored on the brewing apparatus or it may be transmitted from a mobile device or networked server.

When running the recipe 201, a feedback loop using the sensors 120-129 to correct for variation between systems, capsules, or environments. In order to establish the system offset, the initial output is started 202 and the total volume of water flow is measured 203 until an increase of mass is seen at the scale sensor 125, 204. This offset is then saved for future reference within the system 205, 213 as well as synchronized to the networked server 401, 101.

The second phase of running a recipe is to follow the flow or pressure profile over the time of the recipe 206-210. During this period, the mass output is tracked and compared to a total mass output target 207. Once the total mass is reached, the output is stopped and the data from the brew cycle is saved into memory and/or the mobile device 111 and/or networked server 101, 401.

To create these unique brewing cycle configurations with simplicity, FIG. 3, a simplified method for adjusting these profiles that makes this possible on both traditional computer screens as well and especially smaller computing devices such as phones has been created. Shown is an embodiment of this interface with adjustments for amounts within a total period 301, the pressure or flow rate at that point in the total cycle 302, and an adjustment of how tightly to follow the points of reference for that profile 303. This example features three stages 304, but a usable profile only needs to contain one setting and can have as many stages as desired by the end user for detailing their desired output. A practical limit of stages may be three to five to allow for enough variation while not being overly complex.

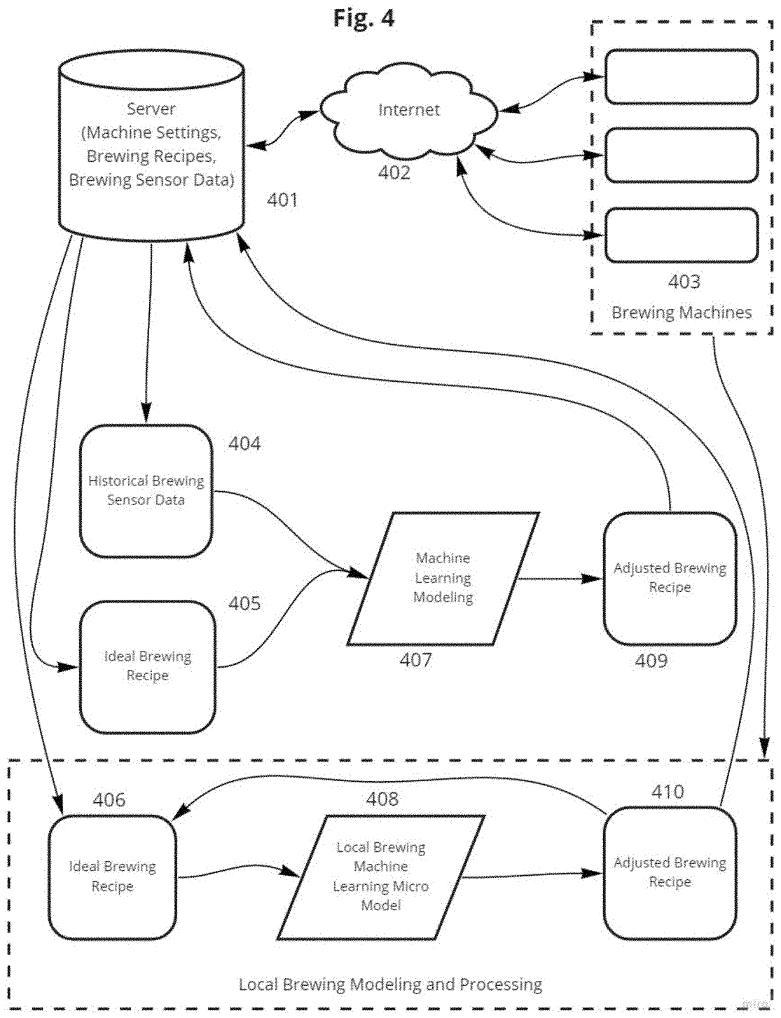

FIG. 4 shows both collecting brewing sensor data from multiple machines, or brewing devices 403 and using that aggregated data to create improved recipes as well as generating machine learning models of the brewing cycle for a given capsule or recipe 404-409. This same data can be used on the Brewing Machine itself 406-410 through a reduced complexity machine learning model 408. This feeds back data into the networked server 401 which then is used to improve the models over time.

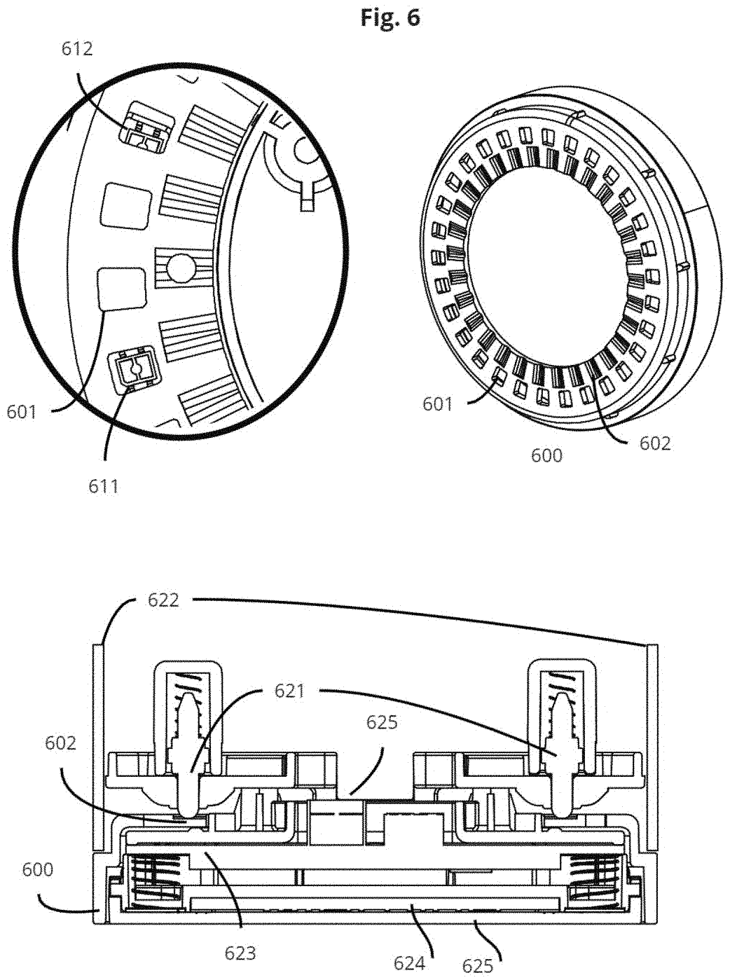

FIG. 6 shows an integrated dial assembly with rotational quadrature sensing for motion and mechanical detent mechanism for tactile feedback to the user. The dial 600, features both quadrature interrupters 601 and detents 602 for this purpose. The integrated quadrature uses less expensive and smaller reflective infrared transmitter pairs directly mounted on the printed circuit board for the system 623. The sensors 611 and 612 as shown in the diagram are a single piece transmitter and receiver package, but it is possible to use discrete components for the same purpose. As shown in 611 and 612, the sensors should be aligned and spaced so that one pair will be partially covered when the other is fully uncovered. This allows for the required quadrature output from the sensors in order to determine direction and speed. A further refinement to this could be to include analog output from the sensors and an adjusted mechanism that varies the distance or the reflectance in order to provide a variable signal output that indicates further detail of where in the movement cycle the dial is currently in.

The mechanical detent mechanism integrated into the assembly allows for greater customization and control of the feedback to the user than using the typical pre-assembled rotary quadrature sensors with click feedback 621, 602. This also allows for a stronger assembly with more material on the mechanism connecting to the base mechanism 625. In this case, the outer casing 622 acts as an outer guide to the bezel, while an inner structure connects to 625 to retain the dial assembly. In this specific implementation, a screen 624 is directly connected to a PCB with microcontroller 623 which also includes touch sensor buttons. The user rotates the bezel using the dial outside 600. As the dial rotates, the spring-loaded plungers 621 alternately seat on the ripple pattern 602 on the inner ring of the dial body.

This mechanism has advantages over the typical rotational sensor used for these devices in that it is more compact, less expensive, and reduces the assembly complexity while allowing for improved feedback and options for higher sensitivity as needed.

Given the control enabled using additional sensors and the integration of their data using feedback control into the brewing process (FIG. 2), it is possible for this brewing apparatus to improve on the brewing quality and consistency. Having lower or no control over these brewing factors typically results in under or over extraction or a ratio of water to the total dissolved solids being too high or low. The result is a brew that is too bitter, too strong, too weak, acidic, or flat tasting. Examples of how this is comparable to the typical experience with existing brewing apparatus follows. Regarding thermal control, typical brewing apparatus found in the market implement a simpler and less consistent method for temperature control. This results in the output over time from one cup to the next being too cool, too hot, or exactly right but only for that one use. By enabling better control over water output temperature, the material that is extracted during brewing stays more consistent, as the water temperature difference of just a few degrees Celsius can drastically change the profile of what is extracted. For example, with different levels of roasting used in coffee, the brewing temperature that extracts the desired soluble materials will vary and is quite specific. In the same way, having an accurate and repeatable amount of water dispensed, repeatable pressure, and flow rate at a given time allows for a brewing recipe to target specific extraction of soluble materials in ways that brewing apparatus lacking this feedback and the means to control the output cannot follow the brewing methods or do even basic brewing in a very repeatable way.

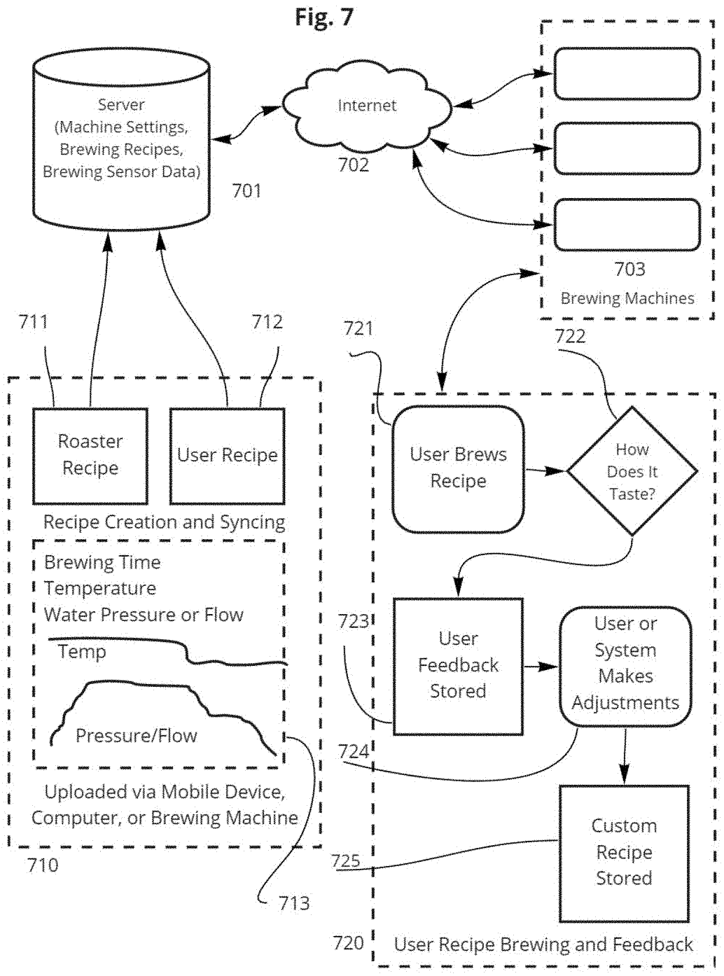

Recipe creation and sharing, discussed in FIG. 3, FIG. 4, and FIG. 7, includes recipes created by roasters or café professional baristas as well as end users. Using the networked connectivity 401 and 402 to store and share these recipes, FIG. 7 illustrates the cycle of recipes being created and shared 710 by brewing professionals, such as roasters or baristas, 711 and users 712. The users then use the recipes 720 to brew 721 on their brewing machine 703. Once the user brews, the machine or the mobile application may request for feedback 722 on the outcome of the brew and can then store that feedback 723 on the server 701. That can then lead to the user or the system making adjustments based on the original recipe 724 which may change the recipe for user preferences or local conditions. For instance, the water used for brewing may impact the solubility of specific materials, and so adjustments may need to be made to account for that impact on the final taste of the brew. Ultimately these adjustments are stored as a custom recipe 725 and also can be stored and shared on the server 701 with other users. Additionally, this feedback process 720 may be incorporated into training data for the machine learning 407 of the brewing process. It will be appreciated that other forms of recipe modification may be made, based upon the source material properties. For instance, individual batches of coffee beans may a moisture content outside a historical range. On this basis, a recipe may be modified to control a brewing device/machine to reflect this change in source material properties.

In terms of capsules used by a consumer, the device may read the batch information on the capsule, which can be entered into a field for selecting a recipe. The batch information, including roasting information, moisture content of the source beans, type and vintage of the source beans, date of roasting, date of capsule sealing, conditions during encapsulation and any other information that may be characteristic of that batch can then be used to select the appropriate recipe. Thus, a recipe may be automatically selected base upon criteria beyond consumer preferences.

As described, the brewing apparatus has the clear advantages over prior art of being able to control the entire brewing process conditions using typical sensors and mechanisms found in the market. The addition of an integrated weighing apparatus, PID controlled water temperature, a feedback loop with water flow closely calibrated to control the water flow or estimated pressure over the brewing cycle, a variable drive pump, and optionally additional direct pressure measurement and feedback all work together to create a controlled brewing process. Layered on top of this is the feature of being able to use and update recipes for brewing cycles that can be generated by roasters or other users and shared through network connectivity as well as being able to select, generate, and control those recipes on the brewing apparatus. With all of these additional features that have the potential of complicating the user interaction, integrating a cost-effective user interface mechanism compliments the total system, as having the additional control with poor methods of interaction would reduce the effective value of them to the end user. These parts allow for an overall more cost-effective solution for a fully controllable capsule brewing system than what is found in the market currently.

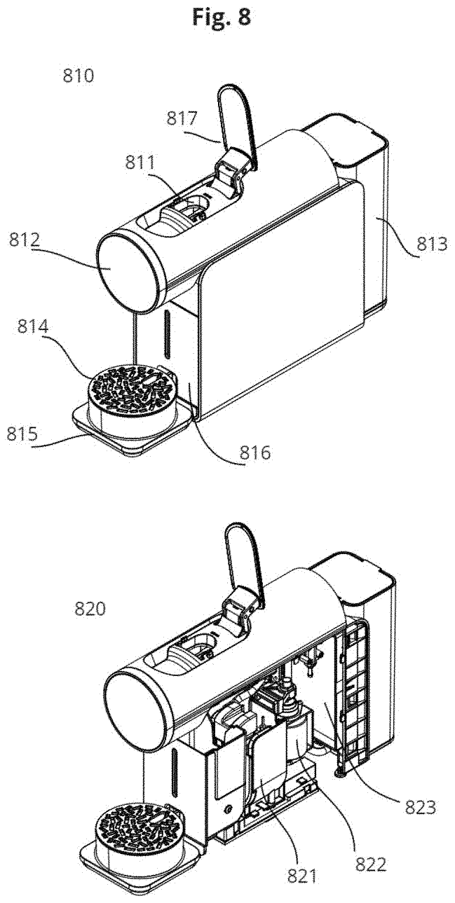

FIG. 8 illustrates one embodiment of the brewing apparatus 810. It features the key components of a capsule entry location breech 811, a handle to open and close the breech for the capsule 817, dial user interface and display 812, removeable water tank reservoir 813, removable drip tray and platform for small cups 814, integrated weighing scale 815, and removable container for capsules and waste water capture 816. This apparatus uses a standard electrical cord to connect to AC current to supply sufficient heating power for bringing the water to brewing temperature quickly.

A partially exposed mechanism view 820 shows some key internal component locations. The water heating block/boiler 821 features one or more integrated temperature sensor(s), such as an NTC thermistor or thermocouple to accurately measure the temperature of the incoming water and the outgoing water. Water is pushed through this heating apparatus 821 by a pump 822 which can be any type of pump which can maintain the required pressure and flow rates while being able to be variably controlled to enable at least ten levels of flow from full to low. The preferred pump for this mechanism is an AC vibratory pump coupled with the appropriate zero cross sensing drive control to selectively turn this pump on and off based on the desired duty cycle as shown in FIG. 5. The power control electronics 823 are located between the tank 813 and the pump 822 in order to reduce the ambient heating of the circuitry from the water heating block 821. These electronics may feature one or more microcontrollers for feedback and control purposes as well as the appropriate electronics for converting from AC household power to DC 12V, 5V or similar as needed by some of the electromechanical components or logic circuitry.

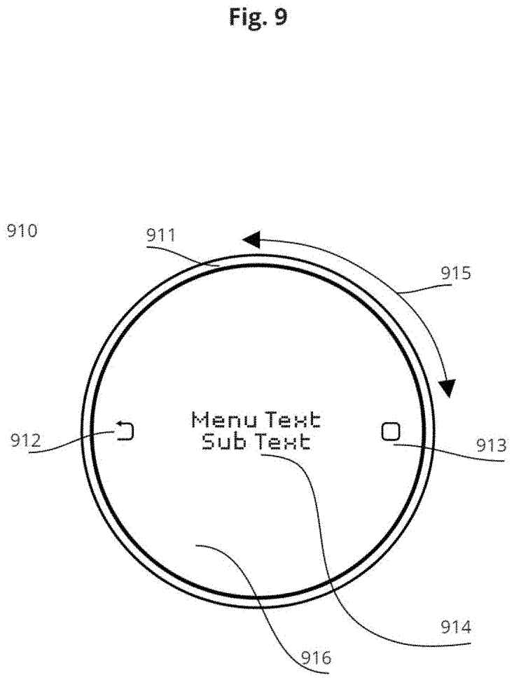

FIG. 9 illustrates the physical user interface and its components 910. There are three main interaction points for the user: a rotational dial 911, back key 912, and enter key 913. A display 914 completes this interface to show the user the information for them to interact with. The dial mechanism and its advantages have been detailed in FIG. 6, but the value to the end user and preferred embodiment details have not been. This dial is freely rotated 915 by grasping the outside surface and applying either a torsional movement about its center or by applying a tangential force along its circumference. Feedback of its rotation is given to the user in three ways: via the screen with changes in the displayed information, via a mechanical detent and the feeling of starting and stopping 602, and via a sound produced by a speaker or buzzer sound emitter controlled by a microcontroller embedded with the display 623. The preferred size of this rotary interface is between 4 cm to 10 cm typically, as a smaller size limits the available surface area for the integrated display 914 and the larger size reaches a limit which a user is unable to interact with the dial using a single hand to firmly touch the outside surface and apply a torsional movement around its center. It is preferred that the movement of this rotation 915 is free without limited ranges such that it is possible to continuously rotate the dial for multiple rotations in any given direction without mechanical limitations on the number of rotations.

The back key 912 and enter key 913 form a pair of interaction points which can be either implemented using mechanical, optical, or capacitive sensing. By reducing the interaction down to these three motions, the user interface is simple and intuitive, allowing for users to interact with the device without initial training other than what may be displayed to them on the integrated display 914. The preferred display for this device is an LED or OLED based display which can be seen through an opaque plastic panel 625, 916. This can alternately be accomplished using an LCD display through a transparent panel. However, the appearance is not as desirable, and the clarity of information is not as good in a wide range of lighting conditions.

FIG. 10 features some typical variations on the abilities of common brewing apparatus and the pressure or brewing profiles they can create. In 1010, 1020, 1030, and 1040, the dotted lines illustrate the flow rate of water through a brewing apparatus and the solid lines represent the pressure. Both are over a time scale.

The profile and system represented by 1010 would be the simplest pumping system without a flow or pressure sensor to provide feedback. In this case, especially with capsule coffee or a portafilter with espresso ground coffee, the system is only able to output at one pressure and one flow rate. The two are dependent on each other with higher pressure creating a reduced flow and vice-versa. As shown in 1011, when extracting the dissolvable solids within the material to be brewed, over time the pressure produced by the material obstructing the free flow of water gradually is carried away by the flow of water. As this happens, the pump will continue at a fixed output and the pressure will reduce while the flow rate will increase. Also, with systems such as these, typically has only the simplest control of turning a pump on and off. Many times, this will be done directly via a manual switch. As a result, this type of system is generally only useful for the most simple of extractions and tends to lack consistency as it depends on the material to be brewed for the flow rate of water through the system.

The system illustrated by 1020 would be one with some basic feedback sensors, such as a water flow meter or pressure sensor. This allows for actions such as a constant pressure output 1021, or a variable flow rate 1022. These systems are typically electronically controlled, which allows for more precise and complicated brewing profiles. This could feature a pre-infusion 1020, which wets out the material to be brewed and may include a reduced flow or pause in the flow of water to allow for steeping of the material in the introduced water. Generally, these systems do not include the ability of adjusting the activation of the pumping apparatus duty cycle or speed and will still tend to follow more simple brewing profiles, 1021.

A more advanced control system 1030, will feature both increased sensing capabilities and accuracy as well as a more capable pumping method and control that allows for higher variation of the flow rate or pressure within the system. It is possible with systems as these to have a lower pressure pre-infusion stage 1031 as well as a high-pressure percolation stage 1032. This typically can be smoothly adjusted to vary the pressure or flow rate during brewing and would be capable of more complicated profiles as shown in 1032 or maintaining a flat profile as in 1033. This kind of control method and capability is found mostly in commercial brewing apparatus or higher-end consumer apparatus, but it is not available in entry level apparatus.

The preferred system of pumping sensing and control 1040 allows for at minimum an approximation of the variable process control as in 1030 as well as short duration pumping timing allowing for an extremely “noisy” pressure or flow profile 1042. This ability to produce short high-pressure spikes of flow with varying duty cycles as described in FIG. 5 is the key to an enhanced brewing process that increases the yield of Total Dissolvable Solids (TDS) within the extracted brew. Additionally, with suitable control systems, physical pumping apparatus, or both, the effective pressure for a given period can be varied 1043 or the flow rate as desired. Controlling the output in this manner requires at minimum at least one sensor for measuring the flow of water from the pump or the pressure at a frequency that is approximately twice the desired rate of change for the system.

As shown in 1040, the approximate preferred brewing profile for extracting a maximum TDS from a limited amount of brewing material requires an initial pre-infusion period 1041. This can be high pressure as shown in 1041 or lower pressure as shown in 1031. An initial higher pressure may be required in the case of encapsulated coffee or other brewing material to rupture a sealing membrane prior to the flow of water through the system. This pre-infusion period may be followed by a pause or a low-pressure period to allow for steeping prior to percolation. Alternately, this pre-infusion period may simply be a low flow or low-pressure period prior to an extended period of flow as needed to complete the extraction within a period that yields the desired extraction.

The percolation period may take the form of a variable profile in either pressure or flow 1032, 1043, but the unique feature that most improves the TDS yield is a series of high-pressure pulses over some portion of the brewing period. The overall brewing time using this method appears tends to be longer with a lower flow rate during the percolation period, but this appears to have the advantage of being less dependent on the brewing temperature than traditional methods. These pressure spikes are typically on the order of 20 milliseconds to 100 milliseconds, so can not be easily replicated through manual operation of equipment. When comparing the TDS level of extractions using this method, it has been found to improve the yield to 50% or more over the typical methods. This increase in TDS level is achieved through, at least, being able to better model the required pressure profile to the flow rate profile. Rather than maintain pressure which may drop off as back pressure drops off, by modelling the recipe profile with imposed pressure spikes, the inevitable drop off as flow rate increases is avoided. Further, the series of pressure variation tends to agitate the brewing material, and thus provide a stirring effect to the material aiding in the dissolution process.

The increase in TDS level is significant for two reasons. Extractions using this method with commonly produced encapsulated coffee have the flavor and consistency of commercial café brewed beverages. However, this is accomplished using approximately half or less of the material to be brewed, and so can be shown to increase the yield of the volume of quality beverage produced by a given amount of base material.

This is a significant innovation within this coffee industry in particular but may be true for other brewed beverages as well. It is forecast that the world's coffee production output will be significantly reduced by 2050 due to global warming induced climate change. This will both increase the cost of coffee in the market as well as make it more scarce, so any technology that reduces the amount of initial material to produce a standard beverage is both very useful as well as timely.

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the to be appended claims. It is further noted that the to be appended claims may be drafted to exclude any optional element. As such, this statement is intended to serve as antecedent basis for use of such exclusive terminology as “solely,” “only” and the like in connection with the recitation of claim elements or use of a “negative” limitation.

Without the use of such exclusive terminology, the term “comprising” in the to be appended claims shall allow for the inclusion of any additional element irrespective of whether a given number of elements are enumerated in the to be appended claim, or the addition of a feature could be regarded as transforming the nature of an element set forth in the to be appended claims. Except as specifically defined herein, all technical and scientific terms used herein are to be given as broad a commonly understood meaning as possible while maintaining to be appended claim validity.

The breadth of the present invention is not to be limited to the examples provided and/or the subject specification, but rather only by the scope of the to be appended claim language. Use of the term “invention” herein is not intended to limit the scope of the to be appended claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the to be appended claims. All references cited are incorporated by reference in their entirety. Although the foregoing invention has been described in detail for purposes of clarity of understanding, it is contemplated that certain modifications may be practiced within the scope of the to be appended claims.

1. A coffee brewing process comprising steps of:
providing a coffee brewing device, having a plurality of coffee brewing elements;
providing end user criteria;
selecting recipes from a remote server based upon the end user criteria, said recipes including at least one data set corresponding to said recipes;
downloading a recipe and a corresponding at least one data set;
adjusting settings of at least one coffee brewing element based upon the corresponding at least one data set; and
brewing coffee using said coffee brewing device the at least one coffee brewing element.

2. The process according to claim 2, wherein the plurality of coffee brewing elements include any one or a combination of: flow pump, and heater.

3. The process according to claim 1, wherein the corresponding at least one data set includes data on required flow rate, temperature and/or pressure corresponding to said recipe.

4. A coffee brewing system comprising:
a plurality of coffee brewing machines;
said plurality of coffee brewing machines in communication with a remote server;
said plurality of coffee brewing machines arranged to receive recipes and corresponding data sets from the remote server;
said plurality of coffee brewing machines further arranged to provide brewing data to said remote server;
wherein the remote server is arranged to receive said brewing data and apply to a machine learning unit, said machine learning unit arranged to use said brewing data to modify the recipes and corresponding data sets for subsequent communication to the plurality of coffee brewing machines.

5. The coffee brewing system according to claim 4, wherein the remote server is arranged to receive additional data to be input to said machine learning unit, said additional data including any one or a combination of: additional recipes and corresponding data sets, recipe modification as a function of coffee bean source, coffee bean type, and customer preference data.
